(19) United States
(12) Patent Application Publication
(10) Pub. No.: US 2026/0156631 A1
(43) Pub. Date: Jun. 4, 2026

(54) ANGLE-OF-ARRIVAL COMMUNICATION FOR ENHANCED BEAM MEASUREMENT AND REPORTING

(71) Applicant: Huawei Technologies Co., Ltd., Shenzhen (CN)

(72) Inventors: Mostafa Medra, Ottawa (CA); Mohammadhadi Baligh, Ottawa (CA)

(21) Appl. No.: 19/448,756

(22) Filed: Jan. 14, 2026

Related U.S. Application Data
(63) Continuation of application No. PCT/CN2023/107445, filed on Jul. 14, 2023.

(51) Int. Cl. H04W 72/0453; G01S 3/14; H04L 5/00

(52) U.S. Cl. CPC H04W 72/0453; G01S 3/14; H04L 5/0048

(57) ABSTRACT

Aspects of the present application relate to communication between the transmitter and the receiver regarding the association between channel paths and beams. One of the transmitter and the receiver may process parameters and measurements received from the other of the transmitter and the receiver. A result of the processing may be that given beams are associated with given channel paths. One of the transmitter and the receiver may use the information for beam switching/tracking/refinement and beam failure recovery.

### CROSS REFERENCE

The present application is a continuation of International Application No. PCT/CN2023/107445, filed on Jul. 14, 2023, the disclosure of which is hereby incorporated by reference in its entirety.

### TECHNICAL FIELD

The present disclosure relates, generally, to wireless communication and, in particular embodiments, to beam measurement and reporting.

### BACKGROUND

Many communications systems are known to improve communication between a transmitter (Tx), with a plurality of Tx antennas, and a receiver (Rx), with a plurality of Rx antennas. The improvements may be based on estimating various properties of a channel between the Tx antennas and the Rx antennas. It may be shown that communications systems that allow for transmission of data in the absence of estimates for the various properties of the channel may suffer from rate loss. It is worth noting that the properties the channel between the Tx and Rx can be different according to the frequency of transmission. For systems with higher frequency bands, e.g., mmWave band systems and THz band systems, the channel may be represented by a plurality of channel paths. Each channel path may have its own power, spatial angle(s) and delay. When a channel path is defined in a way that connects the Tx to the Rx directly, the channel path may be referred to as a line-of-sight, or “LOS,” channel path. When a channel path is defined to connect the Tx to the Rx indirectly, that is, the signals on the channel path are subjected to reflection, diffractions or penetration relative to one or more obstacles, the channel path may be referred to as a non-line-of-sight, or “NLOS,” channel path.

Since higher frequency devices are usually equipped with many antennas, phase shifters can be used to perform analog beamforming. Analog beamforming is known to involve producing beams with power focused in one or more specific directions. Different beams may be used with different power focusing properties and with different beam width properties. One or more beams may be transmitted from one device and, at another device, received and measured in a manner that allows the channel paths to be captured. Once a given beam has been identified as providing a relatively high received power, it is assumed that the given beam has been, somehow, aligned with a relatively good channel path and the given beam may be used for subsequent communication. Typically, in beam-based communication, sets of beams are transmitted and, upon receipt, properties of the received beams are measured and evaluated on the basis of one or more metrics. The metrics may, e.g., include signal-to-noise ratio (SNR), signal-to-interference-and-noise ratio (SINR), reference signal received quality (RSRQ), signal power, etc. In known systems, a transmitter (for example, a base station, “BS”) may use some beams for beam sweeping. A receiver (for example, a user equipment, “UE”) may monitor for and, upon receipt, measure some configured beams. The UE may provide, to the BS, feedback regarding these beams. The feedback may be referred to as “periodic beam reference signal received power (RSRP) reporting.” In one scenario, the UE measures a set of received beams and feeds back, to the BS, an indication of the RSRP of the beams with the greatest RSRP. For example, the UE may feedback, to the BS, the four highest RSRP values and the four beam indices, or beam identifiers, that correspond to the four highest RSRP values. In another example, the UE feeds back, to the BS, a function of selected RSRP measurements. The selected RSRP measurements may be filtered from among a certain number of measurements.

The BS may use such feedback for various beam management procedures. In one example, the BS may decide to switch communication to one UE from one beam to another in a beam switching procedure. In another example, the BS may use a second beam in a vicinity (in terms of angular domain) of a communicating beam for a beam tracking procedure. That is, the BS may use the second beam for, e.g., tracking movement of the UE. The beam tracking procedure may also include making changes to the beam in a way that allows the beam to keep track of the UE.

In one example, making changes to the beam may involve making slight changes to the beam angle of departure (AoD) so that the UE may experience an RSRP that is relatively higher than the RSRP that would be expected in a case wherein no changes are made to the beam AoD. The BS may also refine the beam used for communication. Refining the beam may, e.g., involve narrowing the beam width to provide a better communication experience, thereby providing conditions amenable to higher communication rates.

In another example, the BS may configure the UE with more than one beam pair, such that the UE may implement a beam failure recovery procedure to use a secondary beam in case of failure of communication over a primary beam. A beam pair refers to a set of two beams used one at the transmitter and the other one at the receiver, respectively, for communication. The BS may also configure the UE to communicate through more than one beam pair. With multiple beam pairs, the transmitter and the receiver utilize corresponding beams in the same beam pair for any given transmission in accordance with a configuration. That is, the BS may configure the UE for so-called “dual connectivity.” In view of the importance of the RSRP, in current standards, for proper beam management procedures, the RSRP measurement and feedback overhead can be large, especially for UEs having relatively high mobility.

### SUMMARY

Aspects of the present application relate to improved communication between the transmitter and the receiver regarding the association between channel paths and beams. One of the transmitter and the receiver may process parameters and measurements received from the other of the transmitter and the receiver. A result of the processing may be that given beams are associated with given channel paths. This association may be shown to provide information that improves various beam-related procedures. The transmitter may use the information for enhancing beam switching/tracking/refinement and beam failure recovery. For beam switching/tracking/refinement, the transmitter may be able to select/refine beams that are more suitable to the receiver in terms of beam coverage and beam time-of-stay, thereby reducing a disadvantageous ping-pong effect. For beam failure recovery, the transmitter may configure the receiver with beams that are more probable to connect when a communicating beam fails. In UL and SL communication directions, the BS may be the entity to configure the UE or UEs with the probable alternative beams for failure recovery.

In known feedback schemes, RSRP values for distinct beams may not relate to distinct channel paths. Accordingly, some of the feedback may be considered to be redundant. That is, RSRP value may be reported for the same channel path while no data is reported for other channel paths. Decisions made regarding which beam is suitable for beam switching and which beam is suitable for beam failure recovery may be considered to be made with insufficient information.

When, according to aspects of the present application, the Rx provides, to the Tx, beam information, such information may be shown to enable the Tx to map channel paths to the beams for which information has been received, thereby resulting in improved classification of the beams. This improved classification may be shown to help enhance beam measurement and reporting, beam switching/tracking/refinement and beam failure recovery.

When, according to aspects of the present application, the Tx provides, to the Rx, beam information, such information may be shown to enable the Rx to map channel paths to the beams for which information has been received, thereby resulting in improved classification of the beams. This improved classification may be shown to help enhance beam measurement and reporting, beam switching/tracking/refinement and beam failure recovery.

According to an aspect of the present disclosure, there is provided a method. The method includes transmitting a pilot signal on a beam, receiving angle-of-arrival associated information for the beam, the angle-of-arrival associated information obtained by processing a measurement of the pilot signal, and transmitting beam characterization information for the beam, the beam characterization information obtained by processing the angle-of-arrival associated information. According to other aspects of the present disclosure, there is provided an apparatus for carrying out this method and a computer-readable medium for causing a processor carry out this method.

According to an aspect of the present disclosure, there is provided a method. The method includes receiving a pilot signal on a beam, transmitting angle-of-arrival associated information for the beam, the angle-of-arrival associated information obtained by processing a measurement of the pilot signal, and receiving beam characterization information for the beam, the beam characterization information obtained by processing the angle-of-arrival associated information. According to other aspects of the present disclosure, there is provided an apparatus for carrying out this method and a computer-readable medium for causing a processor carry out this method.

According to an aspect of the present disclosure, there is provided a method. The method includes transmitting a pilot signal on a beam, transmitting angle-of-departure associated information for the beam, and receiving beam characterization information for the beam, the beam characterization information obtained by processing the angle-of-departure associated information. According to other aspects of the present disclosure, there is provided an apparatus for carrying out this method and a computer-readable medium for causing a processor carry out this method.

According to an aspect of the present disclosure, there is provided a method. The method includes receiving a pilot signal on a beam, receiving angle-of-departure associated information for the beam, and transmitting beam characterization information for the beam, the beam characterization information obtained by processing the angle-of-departure associated information. According to other aspects of the present disclosure, there is provided an apparatus for carrying out this method and a computer-readable medium for causing a processor carry out this method.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a plot of reference signal received power (RSRP) values for each beam among a plurality of beams generated using a plurality of antennas at a transmitter;

FIG. 7 illustrates a plot of RSRP values for each beam among a plurality of beams generated using a plurality of antennas at a transmitter;

FIG. 8 illustrates a plot of RSRP values for each beam among a plurality of beams generated using a plurality of antennas at a transmitter;

FIG. 9 illustrates a plot of RSRP values for each beam among a plurality of beams generated using a plurality of antennas at a transmitter;

FIG. 10 illustrates, in a time flow diagram, interaction between a transmitter and a receiver, in accordance with aspects of the present application; and

FIG. 11 illustrates, in a time flow diagram, interaction between a transmitter and a receiver, in accordance with aspects of the present application.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-transitory, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

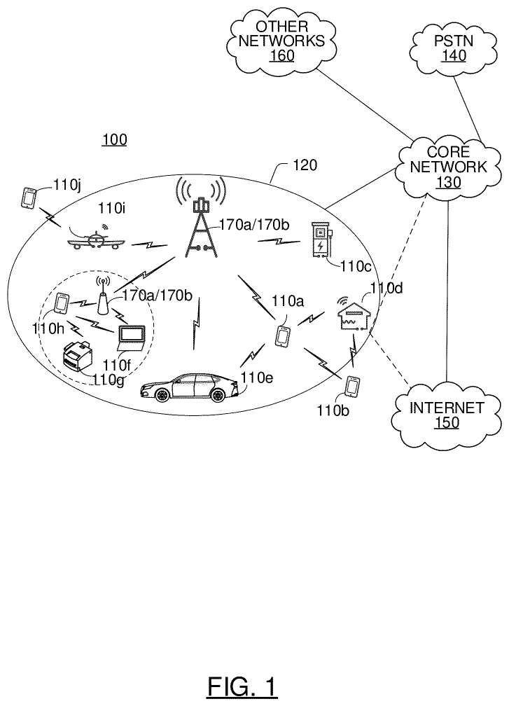

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

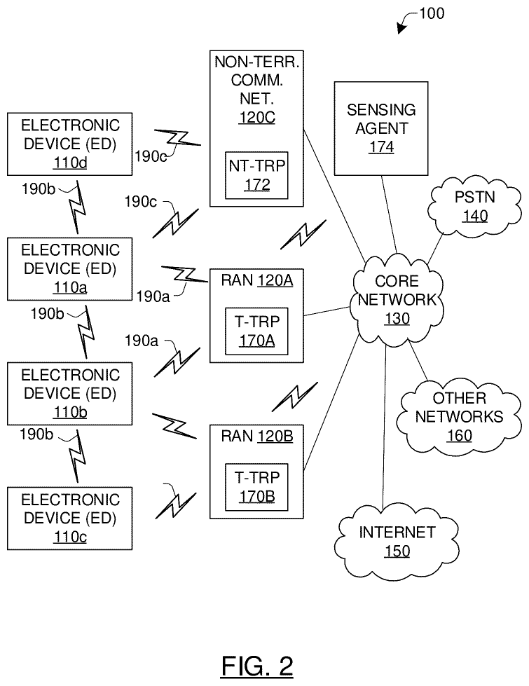

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Discrete Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

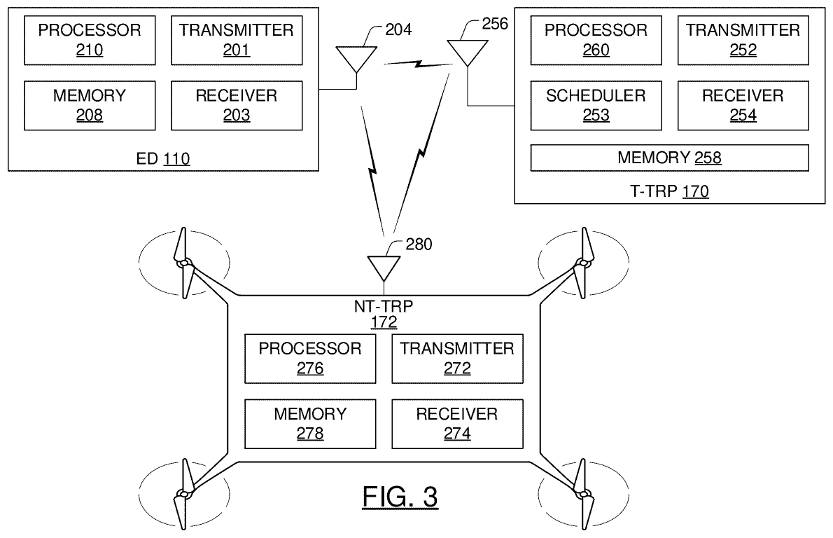

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-transitory storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

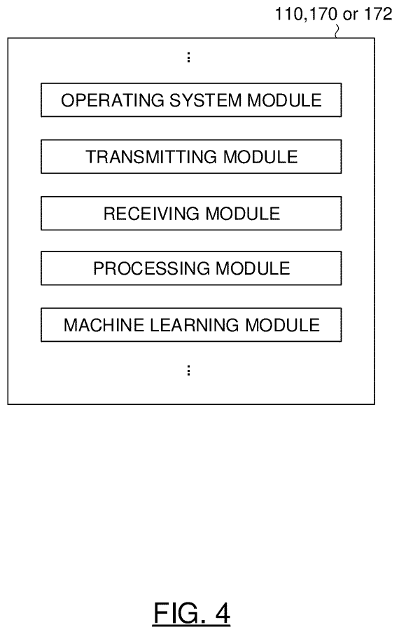

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Discrete Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse Discrete Fourier Transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, B/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

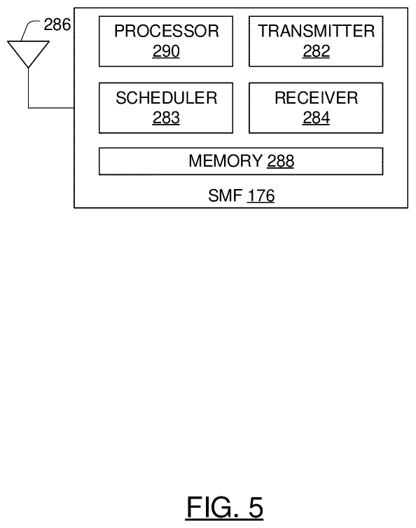

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=a (t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat2} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

In U.S. Pat. No. 10,382,230 to Wang, et al., channel estimation is enhanced using information obtained about angle-of-arrival (AoA) and angle-of-departure (AoD) angular spread. U.S. Pat. No. 10,306,419 to Abou-Rizk, et al., may be viewed as one example, among many examples, wherein information from AoD or AoA is exploited to obtain location information (position or range) for one device or more than one device. In U.S. Pat. No. 10,986,644 to Jianghong, et al., AoD/AoA may be used for beam selection.

UE beam measurement and reporting, for a number of configured beams that are expected to be used for various beam management procedures, may be understood to represent a large overhead, especially in the case of high mobility UEs. In addition, known UE feedback may be shown to fail to provide differentiation between a beam that may be used for beam switching/tracking and a beam that may be used for beam failure recovery.

It may be shown that the conventional approach of a combination of a large overhead and a failure to provide differentiation leads to frequent beam switching/tracking, at least some of which may be deemed unnecessary. Accordingly, the conventional approach may be shown to waste time and resources. Furthermore, the conventional approach may be shown to result in relatively slower beam failure recovery, as the UE may not have awareness of the beam that is expected to be the best beam for beam recovery.

In the following, the terminology used may be understood to apply DL-based measurement. That is, the BS sends some RS (e.g., CSI-RS) and the UE obtains measurement results and feeds back the measurement results according to a configuration and/or uses the measurement results to improve a beamformer in the UE side. However, it can be shown that aspects of the present application easily extended to UL-based measurement or Sidelink-based measurement, where a RS is sent by the UE (e.g., SRS) and the BS, or another UE, obtains measurement results for the channel and reports the measurement results and/or utilizes the measurement results for improving its own beam. In the following, when a downlink-based measurement approach is used; BS sends some RS and UE obtains some measurements, the communication following this downlink-based measurement may be DL, or UL; the BS may continue to be the transmitter or the BS may switch role to a receiver. Also, the UE may continue being the receiver or switch role to a transmitter. Accordingly, the AoD of a transmitter beam may become an AoA of a receiver beam (or a function thereof) and vice-versa. The same logic applies when UL-based measurements is used as well.

In overview, aspects of the present application relate to BS-UE communication that may be shown to enable mapping between different beams and channel paths, thereby resulting in a better understanding of each channel and a better understanding of the beams suitable for various beam management procedures.

Aspects of the present application may be shown to enable a BS-UE communication that allows measured beam pairs to be mapped to channel paths, thereby providing more information than is conventionally available regarding each beam pair. Accordingly, more suitable beams may be used for beam switching/tracking and beam failure recovery. Accordingly, efficiency in these, and other, beam procedures may be seen to have been enhanced.

It is proposed herein that beam measurement alone is not enough to allow network elements to determine a manner in which specific channel paths are mapped to specific beams.

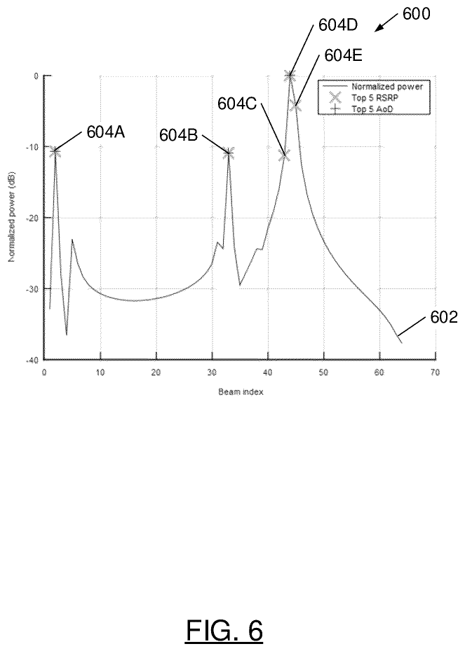

In each of FIGS. 6-9, a channel is randomly generated using a ray-tracing program operating at 60 GHz. The channel is for a 64-antenna element. It is assumed that the Tx is capable of transmitting 64 different beams that are obtained from an orthonormal Discrete Fourier Transform (DFT) codebook. The received power (RSRP) is plotted, as obtained from multiplying a channel with each DFT beam. For each of FIGS. 6-9, RSRP is shown in dB scale versus the indices of the DFT beams.

FIGS. 6-9 may be seen as a spatial/angular power distribution for each channel for the DFT codebook, since the antenna is Uniform Linear Array (“ULA”) and the beam indices are assigned in a consecutive order of beam direction. It is worth noting that, for other antenna configurations, such as Uniform Planar Array (“UPA”), the beam indices of physically adjacent beams are not necessarily consecutive. The channel may be shown in other domains as well, e.g., a channel impulse response (CIR)/delay domain. In a more general case, the beam RSRP is a function defined on R⁵→R, where the domain includes delay (or relative delay in case of time ambiguity) and angular components on the 3D coordinates both at the transmitter and at the receiver, such as elevation and azimuth and the co-domain is the RSRP (linear or dB). FIGS. 6-9 may be treated as the projection of the aforementioned function on R→R, suppressing the delay and elevation axes as well as the azimuth axis at the receiver side.

Logically, it may be shown to be beneficial if the beam measurement and feedback allow identification of distinct channel paths, including channel paths that are useful for various beam management procedures. It should be clear that the beams that may be useful for beam switching/tracking are likely distinct from the beams that may be useful for beam failure recovery.

Measurements and feedback may also be shown to be helpful for beam refinement. For example, a given UE that is moving may track to an adjacent beam as the given UE passes from a coverage area of a first beam to a coverage area of a second beam. From the perspective of a BS, the given UE may be understood to pass from a coverage area of a first beam with a first beam index, x, to a coverage area of a second beam with a second beam index, x+1, assuming that the first beam and the second beam are angularly sequential (e.g., DFT codebook with ULA).

If a beam is blocked, the blockage may span several degrees or beam indices, resulting in a higher probability that the neighboring beams may also be blocked. It follows that the neighboring beams may not be good candidates for beam failure recovery procedures. Accordingly, it may be shown to be beneficial, when selecting beams for beam failure recovery, to select beams that have different angular positions, e.g., different AoA and/or AoD. A beam failure recovery procedure may be triggered responsive to a blockage. If the blockage is near the Tx, the blockage may span several Tx beams, where the several Tx beams have similar AoD. If the blockage is near the Rx, the blockage may span several Rx beams, where the several Rx beams have similar AoA.

Plots illustrated in FIGS. 6-9 have been produced using ray tracing generated channels. Consider that a given UE may be configured to measure RSRP values and transmit feedback including the top five RSRP values.

FIG. 6 illustrates a plot 600 of RSRP values for each beam among the 64 beams generated using the 64 antennas at the BS. The RSRP values normalized to the one RSRP value with the highest value (0 dB). A plotline 602 connects the 64 normalized RSRP values. It may be considered that there are a plurality of distinct channel paths. Indeed, it may be considered likely that the number of channel paths is significantly lower than the number of beams. Each distinct channel path may be understood to be associated with a peak, or “lobe,” in the plotline 602.

Each of the top five RSRP values are associated with a reference numeral, including: a first RSRP value 604A; a second RSRP value 604B; a third RSRP value 604C; a fourth RSRP value 604D; and a fifth RSRP value 604E. Notably, only three RSRP values (the first RSRP value 604A, the second RSRP value 604B and the fourth RSRP value 604D), among the top five RSRP values, may be understood to correspond to distinct channel paths associated with specific AoDs. The remaining two RSRP values (the third RSRP value 604C and the fifth RSRP value 604E), among the top five RSRP values, may be understood to merely be on a lobe corresponding to one of the channel paths. It follows that these two RSRP values (604C, 604E) fail to correspond to distinct channel paths.

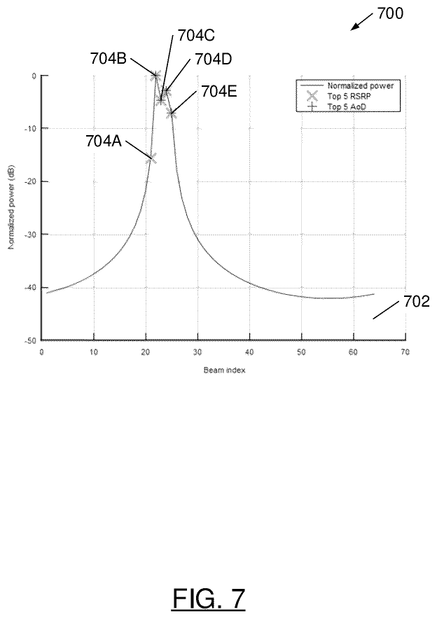

FIG. 7 illustrates a plot 700 of RSRP values for each beam among the 64 beams generated using the 64 antennas at the transmitter. A plotline 702 connects the 64 normalized RSRP values. Each of the top five RSRP values are associated with a reference numeral, including: a first RSRP value 704A; a second RSRP value 704B; a third RSRP value 704C; a fourth RSRP value 704D; and a fifth RSRP value 704E. Notably, a group of four RSRP values (the second RSRP value 704B, the third RSRP value 704C, the fourth RSRP value 704D and the fifth RSRP value 704E), among the top five RSRP values, may be interpreted as being associated with four distinct channel paths, with four distinct AoDs. Notably, the four RSRP values (704B, 704C, 704D, 704E) are associated with beam indices that are close to each other. It follows that the beams corresponding to these four beam indices are physically adjacent and have sequential AoD range. It also follows that it is probable that, in a situation wherein one of the beams is blocked, the other three beams will also be blocked. For UL direction, the beamformer is at the BS, which is the receiver and the corresponding angle is AoA.

The first RSRP value 704A, which is not part of the group of four RSRP values, may be understood to not correspond to a channel path.

If a UE 110 is operating using the beam with the maximum RSRP value, i.e., the second RSRP value 704B, then it may be shown that it is preferred, for purposes of beam switching/tracking, that the UE 110 be prepared to switch to a neighboring beam, e.g., the beam with the third RSRP value 704C. Beneficially, the neighboring beam may provide consistent power as the UE 110 moves. In contrast, for purposes of beam failure recovery, the right-most beam (the beam associated with the fifth RSRP value 704E) may be considered the best beam. This consideration is based on the beam associated with the fifth RSRP value 704E being furthest, in terms of AoD, from the operating beam with the maximum RSRP value, i.e., the second RSRP value 704B. Accordingly, the beam associated with the fifth RSRP value 704E may have lower probability of blockage, compared to the beam associated with the third RSRP value 704C and the beam associated with the fourth RSRP value 704D, when the operating beam is blocked.

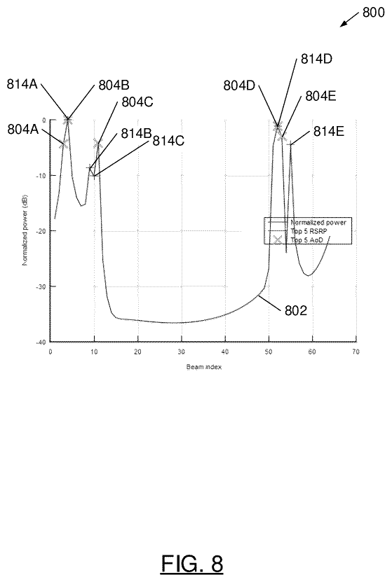

FIG. 8 illustrates a plot 800 of RSRP values for each beam among the 64 beams generated using the 64 antennas at the transmitter. A plotline 802 connects the 64 normalized RSRP values. Each of the top five RSRP values are associated with a reference numeral, including: a first RSRP value 804A; a second RSRP value 804B; a third RSRP value 804C; a fourth RSRP value 804D; and a fifth RSRP value 804E. Notably, the plotline 802 of FIG. 8 contains many more lobes than the plotline 702 of FIG. 7, thereby indicating more channel paths. An experienced reviewer of the plotline 802 of FIG. 8 may be able to indicate that there is evidence of five channel paths, labeled as: first channel path evidence 814A; second channel path evidence 814B; third channel path evidence 814C; fourth channel path evidence 814D; and fifth channel path evidence 814E. Notably, the top five RSRP values appear to only relate to two channel paths among the five identifiable channel paths. In particular, the beam associated with the second RSRP value 804B appears to relate to a first channel path (reviewing from left to right) and the beam associated with the fourth RSRP value 804D appears to relate to a fourth channel path (reviewing from left to right). Unfortunately, it appears that the peaks of three channel paths are not associated with one of the top five RSRP values in that each of those peaks have an RSRP value that is lower than the lowest RSRP value among the top five RSRP values. The first RSRP value 804A appears to be on a side lobe of the peak identifying the first channel path, which peak is associated with the second RSRP value 804B. The fifth RSRP value 804E appears to be on a side lobe of the peak identifying the fourth channel path, which peak is associated with the fourth RSRP value 804D. The third RSRP value 804C appears to be on a side lobe of a combination of peaks identifying a second channel path and a third channel path.

It is notable that the measurements alone fail to provide a full story. Indeed, the measurements do not provide information about the AoA of each beam at the Rx. It is understood that a plurality of Tx beams may be received by the same Rx beam.

Given that it is associated with the greatest RSRP value, the beam associated with the second RSRP value 804B may be the beam selected for use for communication. The beam associated with the fourth RSRP value 804D appears to be a good candidate for selecting for use in a beam recovery procedure. However, what is not presented in FIG. 8, but can be obtained from channel components available from the ray tracing program, is that the beam associated with the second RSRP value 804B and the beam associated with the fourth RSRP value 804D have a common AoA. If a beam blockage happened due to an obstacle blocking the common AoA, both beams will be blocked. It follows that it may be shown that another beam, having an AoA that is distinct from the common AoA, would be a better candidate for selecting for use in a beam recovery procedure.

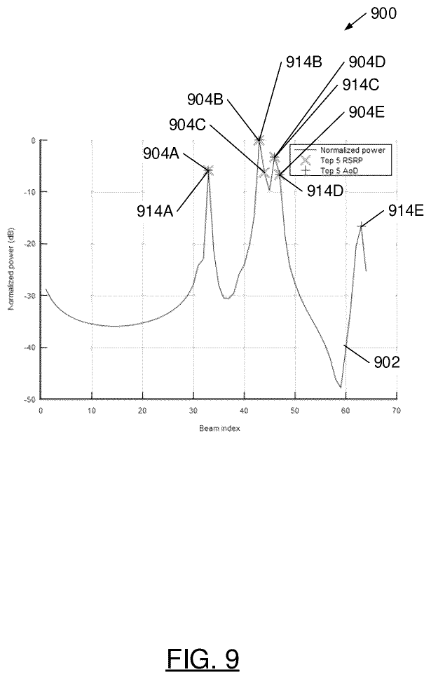

FIG. 9 illustrates a plot 900 of RSRP values for each beam among the 64 beams generated using the 64 antennas at the transmitter. A plotline 902 connects the 64 normalized RSRP values. Each of the top five RSRP values are associated with a reference numeral, including: a first RSRP value 904A; a second RSRP value 904B; a third RSRP value 904C; a fourth RSRP value 904D; and a fifth RSRP value 904E. Notably, the plotline 902 of FIG. 9 contains a plurality of lobes, in common with the plotline 802 of FIG. 8, thereby indicating a plurality of channel paths. An experienced reviewer of the plotline 902 of FIG. 9 may be able to indicate that there is evidence of five channel paths, labeled as: first channel path evidence 914A; second channel path evidence 914B; third channel path evidence 914C; fourth channel path evidence 914D; and fifth channel path evidence 914E. Notably, the top five RSRP values appear to only relate to four channel paths among the five identifiable channel paths. In particular, the beam associated with the first RSRP value 904B appears to relate to a first channel path (reviewing from left to right). The beam associated with the second RSRP value 904B appears to relate to a second channel path. The beam associated with the fourth RSRP value 904D appears to relate to a third channel path. The beam associated with the fifth RSRP value 904E appears to relate to a fourth channel path. Unfortunately, it appears that the peak of the fifth channel path is not associated with one of the top five RSRP values in that the peak of the fifth channel path has an RSRP value that is lower than the lowest RSRP value among the top five RSRP values. The third RSRP value 904C appears to be on a side lobe of the peak identifying the second channel path, which peak is associated with the second RSRP value 904B.

Determining certain information may be shown to be helpful to the task of mapping specific channel paths to specific beams.

First, it may be shown to be helpful to determine whether the beams are angularly sequential, e.g., sequential AoD. It is known that the domain of beam indices, i, where 1≤i≤64, may be mapped to a domain of AoDs, 0≤AoD≤2π. Sequential AoDs may be expressed, in radians, as:

$$[ \frac{π}{32} , \frac{π}{16} , … , \frac{i π}{32} , … , \frac{63 π}{32} , 2 π ] .$$

Sequential AoDs may be expressed, in degrees, as: [5.625°, 11.25°, . . . , 5.625i°, . . . , 354.375°, 360°].

Second, it may be shown to be helpful to determine an AoA to associate with each received beam. In a case wherein a first beam and a second beam have sequential AoDs and similar AoAs, the second beam may be considered a good candidate for a beam tracking procedure in respect of the first beam. The inverse is also true. In the same case, the first beam and the second beam may be shown to have a higher probability of being blocked together than two randomly selected beams. Accordingly, the second beam may be considered to be a poor candidate for a beam failure recovery procedure in respect of the first beam. The inverse is also true.

A second beam that has a similar AoA to the AoA of a first beam but has an AoD that is far apart from the AoD of the first beam may be regarded as a good candidate for a beam failure recovery procedure in respect of the first beam for those cases wherein the beam failure recovery procedure is implemented as a result of a blockage by objects near the transmitter.

Conversely, a second beam that has a similar AoD to the AoD of a first beam but has an AoA that is far apart from the AoA of the first beam may be regarded as a good candidate for a beam failure recovery procedure in respect of the first beam for those cases wherein the beam failure recovery procedure is implemented as a result of a blockage by objects near the receiver. An example blockage by an object near the receiver is a user hand, e.g., when the receiver is a handheld device.

In scenarios with relatively wide bandwidth, it may be considered that temporal resolution is relatively high. In such scenarios, information on AoD and AoA may be shown to be useful to associate different beams utilizing different channel paths. Aspects of the present application relate to obtaining associations between beams and respective channel paths. Aspects of the present application relate to a Tx and an Rx communicating information regarding the Tx beam AoD and the Rx beam AoA. Once the Tx or the Rx is able to map a given beam to a given channel path, it may be considered that the given beam has been classified. Conveniently, the classification of the given beam may be shown to lead to more appropriate use of the given beam for the various beam management procedures.

Aspects of the present application relate to enhanced beam measurement and reporting. Indeed, by providing, according to aspects of the present application, feedback that is relevant to the beam procedures, it may be shown that unnecessary feedback is reduced.

Aspects of the present application relate to an exchange of information. The exchange may be shown to enhance beam switching/tracking, thereby resulting in fewer switching events. It may be shown that one consequence of fewer switching events is a reduction in overhead associated with switching events. The beam switching/tracking may be shown to be enhanced through finding of beam groups with relatively higher aggregate time-of-stay.

For beam failure recovery, through the establishment of an association between a given beam and a given channel path, aspects of the present application may be shown to relate to identifying those beams that have relatively lower probability of being blocked when the communicating beam is blocked. Such identifying may be shown to lead to a reduction in the time overhead that is associated with beam failure recovery procedures.

A term, “blockage correlation,” is coined herein to quantify a conditional probability of a first beam being blocked given that a second beam is already blocked. For example, if two beams have the same AoD and the same AoA and one beam is blocked, then it follows that the other beam is very likely to also be blocked. It may be said that these two beams are highly correlated in terms of blockage. It may be determined that, if one beam is blocked, then the other beam would be a poor choice for a beam failure recovery procedure. If two beams have a different AoA (a first AoA and a second AoA) and a different AoD, then it may be expected that an object that blocks the first AoD may not, necessarily, block the second AoD. The object may be called an independent blockage. There may also be two beams that are received by two different Rx beams, that is, each beam may be received, at the UE, using a distinct panel. Some hand blockages that cover one panel may not cover the other panel, with some dependance on the manner in which the hand of the user grasps the UE. Accordingly, it may be that these two beams have conditional blockage probabilities that are inversely correlated to each other. That is, if one beam is blocked, then the other beam is likely not blocked. Of course, it may be shown that the wireless communication environment in which the TX and the Rx are operating is expected to play a role in establishing a degree to which a blockage on a given beam changes the conditional blockage probability associated with other beams. In general, the conditional blockage probability is expected to fall into one of three categories: positively correlated; independent (uncorrelated); and inversely correlated. The conditional blockage probability may be shown to be a useful parameter to factor into the selection of beams for beam switching/tracking procedures and the selection of beams for beam failure recovery procedures.

Note that two channel paths may have independent short-term fading or correlated short-term fading. The degree to which the short-term fading of two channel paths is correlated may be obtained by observing an evolution of the RSRP associated with each channel path over time. If a two given channel paths have independent short-term fading, then two given channel paths may be considered as a good pair for reliability and dual connectivity.

It has been stated hereinbefore that, responsive to establishing that two given beams are angularly sequential, it follows that a determination may be made that the two given beams may be suitable for beam tracking. Notably, such a determination may be considered to further depend on the location of the UE that receives the two given beams. Those UEs that are relatively close to the BS may experience wider angular changes responsive to movement compared to those UEs that are relatively far from the BS. Accordingly, any angular difference factor that is considered in a beam tracking procedure may be considered to be UE-location dependent. Furthermore, the angular difference factor may also be considered to be deployment dependent. That is, the angular difference factor may be given one weight in an indoor deployment scenario and another weight in an outdoor deployment scenario.

There exist conditions under which the AoA and the AoD may refer only to the azimuth angle. One condition is that the antennas are arranged in a linear fashion, e.g., the antennas are arranged in a uniform linear array. Another condition is that the elevation of each beam is pre-determined or known, for example, for pedestrians. There exist conditions under which the AoA and the AoD may refer to an angle pair: azimuth angle; and elevation angle. One condition is that the antennas are arranged in a planer fashion, e.g., the antennas are arranged uniform planer array. There may be other angles that describe how the channel path propagates between the Tx and Rx and the explanation above used one example to illustrate, but not to limit the scope of the protect afforded to aspects of the present application.

Aspects of the present application may be shown to extend to other channel representations.

For example, if the CIR is used, a measurement of delay may be shown to be representative of a quantity of different paths taken by the signal as the signal propagates from the Tx to the Rx. Accordingly, the delay measurement may be part of the information that may be used to classify different channel paths.

Notably, while beam blockage has been discussed hereinbefore in association with beam failure recovery, beam blockage is discussed merely as an example trigger for beam failure. It should be clear that beams may fail for a variety of different reasons. For example, a beam with a relatively high fluctuating power may be considered to have failed when the power falls relatively low. Aspects of the present application may be understood to extend to differentiating such beams according to AoA, AoD and/or delay, for just three example characteristics. For example, responsive to identifying, based on “too much” power fluctuation, a given channel path as unreliable, beams that use the given channel path may be removed from a list of beams that may be considered for either beam tracking procedures or beam failure recovery procedures.

Aspects of the present application relate to channel-path-to-beam mapping. Accordingly, it may be shown that aspects of the present application may be applicable to any beam-based communication. It may also be shown that aspects of the present application may be applied for either FDD systems or TDD systems. While examples presented herein may be seen to focus on the UE and the BS in a DL measurement scenario, it should be clear that aspects of the present application may be applicable to UL measurement scenarios and to sidelink measurement scenarios. Beams may originate in a serving cell. Beams may originate in another cell, such as a secondary cell or one of a plurality of cells that are under consideration for a possible hand-over procedure.

In aspects of the present application, the Tx may determine a manner in which a given channel path is mapped to one or more beams. To assist the Tx in determining such mapping, the Rx may communicate with the Tx. In particular, the Rx may indicate, to the Tx, information regarding an AoA corresponding to various beams among a plurality of beams. There can be various approaches for such indication. The approach may depend on a quantity of information that the Rx is willing to share and a degree of detail that is expected for the mapping between the channel path and the one or more beams.

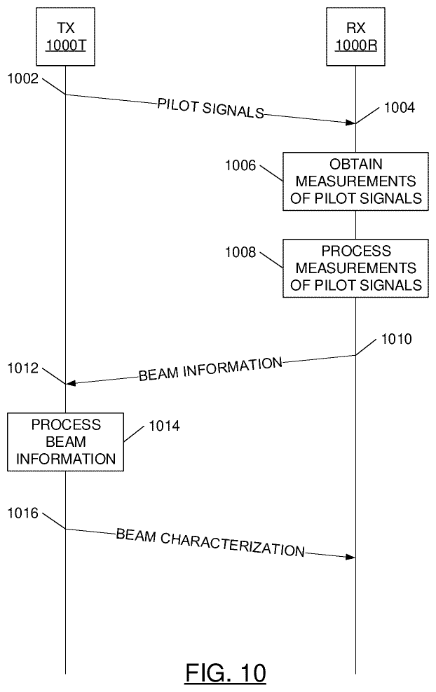

FIG. 10 illustrates, in a time flow diagram, interaction between a Tx 1000T and an Rx 1000R.

The Tx 1000T starts the communication by transmitting (step 1002) a plurality of pilot signals. The pilot signals may be transmitted (step 1002) on a plurality of beams as part of other signals, such as SSBs, CSI-RS, SRS and/or positioning reference signal (PRS). Upon receipt (step 1004) of the pilot signals, the Rx 1000R may obtain (step 1006) measurements of the channel spanned by the received beams. The Rx 1000R may then process (step 1008) the measurements. By processing (step 1008) the measurements, the Rx 1000R may determine an RSRP to associate with each received beam among the plurality of received beams. By processing (step 1008) the measurements, the Rx 1000R may determine an AoA to associate with each received beam among the plurality of received beams. By processing (step 1008) the measurements, the Rx 1000R may determine that there are a plurality of channel paths between the Tx 1000T and the Rx 1000R. By processing (step 1008) the measurements, the Rx 1000R may determine a delay to associate with each channel path among the plurality of channel paths.

In one approach, the Rx 1000R may transmit (step 1010), to the Tx 1000T, beam information. The beam information may include beam-specific RSRP information. The beam information may also include an indication of at least one AoA that is associated with at least one received beam. The AoA that is associated with a received beam may be understood to, generally, be the angle that corresponds to the largest peak in the angular domain when receiving the received beam. If a given received beam has more than one peak, at more than one angle, the Rx 1000R may transmit (step 1010) more than one indication of AoA, with the number of AoAs corresponding to the number of peaks. The AoA values may be quantized to a certain number of bits that may be set by default or configured by the BS when the Rx 1000R is the UE.

Upon receipt (step 1012), from the Rx 1000R, of the AoA information, the Tx 1000T may process (step 1014) the beam information to map specific channel paths to specific beams. As a result of having processed (step 1014) the beam information, the Tx 1000T may determine a mapping between the channel paths and the beams, called a channel-path-to-beam mapping, herein. On the basis of the channel-path-to-beam mapping, the Tx 1000T may characterize the beams. That is, the Tx 1000T may determine the beams that are candidates for beam tracking and the Tx 1000T may determine the beams that candidates for BFR. The Rx 1100R may then transmit (step 1016), to the Rx 1000R, an indication of the characterizations of the beams.

The Tx 1000T may or may not understand how the indications of AoAs, indicated in Rx-local coordinates, map to Tx-local coordinates. However, it should be clear that, even if the Tx 1000T does not understand how to map a given AoA value, indicated in Rx-local coordinates, to Tx-local coordinates, the Tx 1000T would still be able to understand how the received AoA values are related to each other. The Rx 1000R may, for example, transmit (step 1010) indications of RSRP measurements for three beams: beam one; beam two; and beam three. The Rx 1000R may also transmit (step 1010) indications of AoA information for the three beams as: beam one, 10 degrees; beam two, 100 degrees; and beam three, 101 degrees. Even if the Tx 1000T lacks a mapping of Rx-local coordinates to Tx-local coordinates, it may be shown that the Tx 1000T would easily recognize that beam two and beam three are relatively close to each other, in terms of AoA, and both beam two and beam three are distinct from beam one. Accordingly, the Tx 1000T may decide, as part of processing (step 1014) the beam information, that beam two and beam three may be used for possible beam switching/tracking. The Tx 1000T may also decide, as part of processing (step 1014) the beam information, that beam one may be a candidate for use in a beam failure recovery process in a case wherein beam two or beam three fails while acting as the communicating beam.

Another way to associate a single channel path with two beams is to track RSRP and channel quality indicator (CQI) evolution over time for the two beams. For example, a highly correlated temporal evolution of RSRP value for two given beams may be interpreted as being indicative of a correlation between the two given beams. It may be expected that the two given beams span the same channel path.

When transmitting (step 1010), to the Tx 1000T, an indication of an AoA that is associated with a specific beam, the Rx 1000R may transmit (step 1010) an index that corresponds, in a codebook that the Rx 1000R is using, to the specific beam. In a case wherein the Tx 1000T receives (step 1012) AoA information, from the Rx 1000R, that is associated with a beam index, the Tx 1000T may be able to associate the beam index directly to the AoA information.

The codebook may be known, at the Tx 1000T, without Rx feedback. For example, the Tx 1000T may, initially, select a codebook for use by the Rx 1000R. Alternatively, the Rx 1000R may inform the Tx 1000T of the codebook being used. Further alternatively, the Tx 1000T and the Rx 1000R may agree on the use of a specific codebook. Even further alternatively, the codebook may be standard defined.

In another approach, the Rx 1000R may not transmit (step 1010), to the Tx 1000T, explicit AoA information. In such case, the Rx 1000R may transmit (step 1010), to the Tx 1000T, AoA information in an implicit manner. In one example, the Rx 1000R may send a group of indications of received beams, wherein each received beam indicated in the group is better received using the same Rx beam. In such case, the Rx 1000R may be expected to transmit (step 1010), to the Tx 1000T, a plurality of groups of beam indices (e.g., {Tx1, Tx3}, {Tx5, Tx2}) and the Tx 1000T may be expected to understand that each group is received by the same Rx beam or a plurality of physically close Rx beams. The Rx 1000R may also group the received beam indices based on a preferred Rx panel. Each distinct panel may have a location that is different from the location of the other panels and/or have an orientation that is different from the orientation of the other panels. While the Tx 1000T may not have explicit information regarding the receive beam, the Tx 1000T may infer that the Tx beams in a given group are received with similar Rx beams. Such an inference may be shown to provide valuable information for channel-path-to-beam mapping. The Rx 1000R may or may not transmit (step 1010), to the Tx 1000T, a group that has only one beam index and the Tx 1000T may automatically understand that such a beam index belongs to a singleton set.

In another approach, the Rx 1000R may group indices of the beams that are received with AoAs that are all within a certain range. For example, in view of a threshold, T, if a difference of the AoAs of two distinct beams does not exceed the threshold, i.e., |AoA₁-AoA₂|<T, then the Rx 1000R may place, in a group, an index that is associated with the beam with AoA₁ and an index that is associated with the beam with AoA₂. The Rx 1000R may then transmit (step 1010), to the Tx 1000T, an indication of the indices that have been placed into the group.

In a further approach, the Rx 1000R may directly transmit (step 1010), to the Tx 1000T, a recommendation for each beam. For example, the Rx 1000R may transmit, to the Tx 1000T, RSRP beam measurements in two groups. A first group of RSRP beam measurements may be for beams that the Rx 1000R recommends as good for beam switching/tracking. The beams in the first group may, e.g., be beams with AoAs that are angularly sequential. A second group of RSRP beam measurements may be good candidates for beam failure recovery. The beams in the second group may, e.g., be beams with different AoA or with independent or inverse blockage probability. The number of beams in each group may be configured by the Tx 1000T or may be fixed.

The aforementioned approaches are general examples that are, by no means, intended to be limiting examples. It should be clear that aspects of the present application span all possible forms of communication that is associated with channel-path-to-beam mapping.

To categorize the beams for possible beam switching/tracking and for possible beam failure recovery, the Tx may use its own AoD information, received AoA information (whether explicit or implicit), beam information and any sensing information. The beams categorized for beam switching/tracking may be continuously monitored until a decision is made to switch to a new beam. Beams categorized for possible beam failure recovery (BFR) may be communicated to the Rx so that the Rx may use the beams categorized for possible beam failure recovery responsive to a failure of the communicating beam. In case of a failure of the communicating beam, both the Rx and the Tx may follow an agreed-upon order of candidate beams for BFR. While channel-path-to-beam mapping, according to aspects of the present application, may be shown to provide information regarding spatial behavior of various channel paths, sensing information may provide additional information that can also be helpful. For example, sensing information regarding the Rx 1000R movements may suggest certain beams to be used for beam switching/tracking or for possible beam recovery. Also, sensing information may predict blockages along certain directions that may provide more information regarding proactive beam switching/tracking.

The Rx may transmit (step 1010) the beam information with a different periodicity then the RSRP measurements periodicity. In one example, the Rx may transmit (step 1010) the beam information and the RSRP in the beginning, but will continue sending only the RSRP value as long as the Rx beam is unchanged. In another example, the Rx 1000R may only transmit (step 1010) beam information when requested by the Tx 1000T for a set of beams periodically reported. In a third example, the Rx 1000R may transmit (step 1010) the beam information only for beams configured by the Tx 1000T and these configured beams may be the same or different from the beams for which the RSRP measurements are transmitted. In another example, the Rx 1000R may transmit (step 1010), to the Tx, an update on the reported AoA for a given beam under various conditions. In one condition, there is a change in the preferred grouping for the given beam. In another condition, there is a significant change in the AoA associated to the given beam.

Aspects of the present application may be applied in a scenario wherein the Tx is a BS and the Rx is a UE. In such a scenario, the downlink beams that are transmitted may include SSB or CSI-RS. Aspects of the present application may be applied in a scenario wherein the Tx is a UE and the Rx is a BS. In such a scenario, the uplink beams that are transmitted may include beams for uplink training, such as SRS. Aspects of the present application may also be applied for a sidelink scenario, wherein both the Tx and the Rx are UEs.

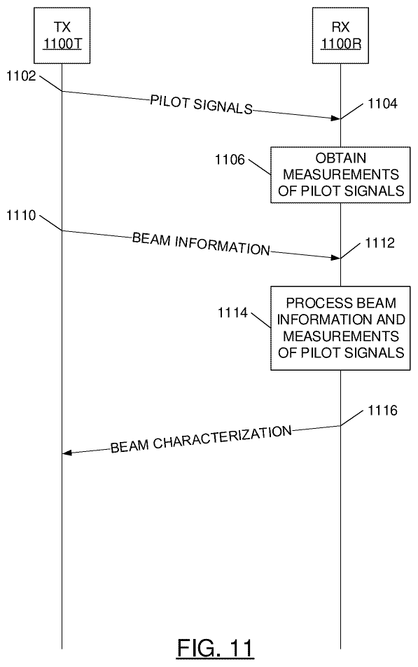

In the foregoing, it was discussed, in view of FIG. 10, that the Rx 1000R may share information with the Tx 1000T. In other aspects of the present application (see FIG. 11), a Tx 1100T may share information with an Rx 1100R.

FIG. 11 illustrates, in a time flow diagram, interaction between the Tx 1100T and the Rx 1100R. In a manner consistent with the time flow diagram of FIG. 10, the Tx 1100T may transmit (step 1102) pilot signals. The pilot signals may be transmitted (step 1102) on a plurality of beams as part of other signals, such as SSBs, CSI-RS, SRS and/or PRS. Upon receipt (step 1104) of the pilot signals, the Rx 1100R may obtain (step 1106) measurements of the channel spanned by the received beams. The Tx 1100T may transmit (step 1110), to the Rx 1100R, beam information. The beam information transmitted (step 1110), by the Tx 1100T, may include a respective AoD corresponding to various transmitted beams. Upon receiving (step 1112) the beam information, the Rx 1100R may process (step 1114) the beam information in conjunction with the measurements of the pilot signals. As a result of having processed (step 1114) the beam information in conjunction with the measurements of the pilot signals, the Rx 1100R may determine a mapping between the channel paths and the beams, called a channel-path-to-beam mapping, herein. On the basis of the channel-path-to-beam mapping, the Rx 1100R may characterize the beams. That is, the Rx 1100R may determine the beams that are candidates for beam tracking and the Rx 1100R may determine the beams that candidates for BFR. The Rx 1100R may then transmit (step 1116), to the Tx 1100T, an indication of the characterizations of the beams.

Various approaches are contemplated for transmitting (step 1110), to the Rx 1100R, beam information. The approach that is selected may be selected based, in part, upon how much information the Tx 1100T is willing to share and the amount of detail that is intended to be present in the mapping between the channel path and the beams.

In one approach, the Tx 1100T may transmit (step 1110) at least one AoD that is associated with each transmitted beam. The AoD of a given Tx beam is, generally, the angle corresponding to the largest peak in the angular domain when transmitting the given Tx beam. If a given Tx beam has more than one peak, at more than one angle, the Tx may transmit more than one AoD value corresponding to the given Tx beam.

The Rx 1100R may or may not understand how the indications of AoDs, indicated in Tx-local coordinates, map to Rx-local coordinates. However, it should be clear that, even if the Rx 1100R does not understand how to map a given AoD value, indicated in Tx-local coordinates, to Rx-local coordinates, the Rx 1100R would still be able to understand how the received AoD values are related to each other. The Tx 1100T may, for example, transmit (step 1110) indications of RSRP measurements for three beams: beam one; beam two; and beam three. The Tx 1100T may also transmit (step 1110) indications of azimuth information for the three beams as: beam one, 10 degrees; beam two, 100 degrees; and beam three, 101 degrees. Even if the Rx 1100R lacks a mapping of Tx-local coordinates to Rx-local coordinates, it may be shown that the Rx 1100R would easily recognize that beam two and beam three are relatively close to each other, in terms of AoD, and both beam two and beam three are distinct from beam one. Accordingly, the Rx 1100R may decide, as part of processing (step 1114) the beam information, that beam two and beam three may be used for possible beam switching/tracking. The Rx 1100R may also decide, as part of processing (step 1114) the beam information, that beam one may be a candidate for use in a beam failure recovery process in a case wherein beam two or beam three fails while acting as the communicating beam.

Another way to associate a single channel path with two beams is to track RSRP and CQI evolution over time for the two beams. For example, a highly correlated temporal evolution of RSRP value for two given beams may be interpreted as being indicative of a correlation between the two given beams. It may be expected that the two given beams span the same channel path.

When transmitting (step 1110), to the Rx 1100R, an indication of an AoD that is associated with a specific beam, the Tx 1100T may transmit (step 1110) a scalar value (e.g., an azimuth angle) or a pair of values (e.g., an azimuth angle and an elevation angle) for the specific beam. The AoD values may be quantized to a certain number of bits that may be set by default or configured by the BS when the Tx 1100T is the UE. Since the angles are measured in the Tx-local coordinate system, the Rx 1100R may not know how to map these values to Rx-local coordinate system. However, the Rx 1100R would still be able to understand the angular relations between the beams. The Tx 1100T and the Rx 1100R may also communicate in order to allow a mapping between the Rx-local coordinates at the Rx 1100R and the Tx-local coordinates at the Tx 1100T.

When transmitting (step 1110), to the Rx 1100R, an indication of an AoD that is associated with a specific beam, the Tx 1100T may transmit (step 1110) an index that corresponds, in a codebook that the Tx 1100T is using, to the specific beam. In a case wherein the Rx 1100R receives (step 1112) beam information, from the Tx 1100T, that is associated with a beam index, the Rx 1100R may be able to associate the beam index directly to the beam information.

The codebook may be known, at the Rx 1100R, without Tx feedforward. For example, the Rx 1100R may, initially, select a codebook for use by the Tx 1100T. Alternatively, the Tx 1100T may inform the Rx 1100R of the codebook being used. Further alternatively, the Rx 1100R and the Tx 1100T may agree on the use of a specific codebook. Even further alternatively, the codebook may be standard defined.

A codebook containing a precoder set and a used codeword (the precoder) within the codebook may be signaled between the Tx 1100T and the Rx 1100R. It should be understood that the information that the Tx 1100T is able to acquire is limited to a quantization level associated with the codebook. As discussed hereinbefore, the Tx 1100T and the Rx 1100R may also communicate in order to allow the mapping between the local coordinate at the Rx 1100R and the Tx 1100T.

In another approach, the Tx 1100T may not transmit (step 1110), to the Rx 1100R, explicit AoD information. In such case, the Tx 1100T may transmit (step 1110), to the Rx 1100R, AoD information in an implicit manner. In one example, the Tx 1100T may send a group of indications of transmitted beams, wherein adjacent indices in the group correspond to angularly adjacent transmitted beams. It may be shown that the Rx 1100R does not, in this case, receive as much information about the various transmitted beams. However, the Rx 1100R may be expected to interpret the information as indicative that certain ones of the transmitted beams have close AoD and others do not. This may still prove to be valuable information for determining channel-path-to-beam mapping in step 1114.

In such case, the Tx 1100T may be expected to transmit (step 1110), to the Rx 1100R, a plurality of groups of beam indices (e.g., {Tx1, Tx3}, {Tx5, Tx2}) and the Rx 1100R may be expected to understand that each group is transmitted on the same Tx beam or a plurality of physically close Tx beams. The Tx 1100T may also group the transmitted beam indices based on a preferred Tx panel. Each distinct panel may have a location that is different from the location of the other panels and/or have an orientation that is different from the orientation of the other panels. While the Rx 1100R may not have explicit information regarding the receive beam, the Rx 1100R may infer that the Tx beams in a given group are received with similar Rx beams. Such an inference may be shown to provide valuable information for the channel-path-to-beam mapping that occurs as part of step 1114. The Tx 1100T may or may not transmit (step 1110), to the Rx 1100R, a group that has only one beam index and the Rx 1100R may automatically understand that such a beam index belongs to a singleton set.

The Tx 1100T may send an index that refers to a new group and one or more indices associated with the Tx beams, in which the Rx 1100R understands that such grouping refers to these Tx beams being angularly adjacent. The Tx 1100T may add new beam indices to one or more group and may remove beam indices from one or more group. The Tx 1100T may also provide, to the Rx 1100R, the same Tx beam index in more than one group if the Tx beam is angularly close to more than one other Tx beam. The Tx 1100T may transmit one group at a time or may transmit more than one group at a time. The Tx 1100T may be configured regarding a manner in which to update the groups and how often to update the groups. In one scenario, the Tx 1100T may only update the groups when a new Tx beam is being transmitted or when the Tx beam corresponding to an existing Rx beam has changed.

In another approach, the Tx 1100T may group indices of the beams that are transmitted with AoDs that are all within a certain range. For example, in view of a threshold, T, if a difference of the AoDs of two distinct transmitted beams does not exceed the threshold, i.e., |AoD₁−AoD₂|<T, then the Tx 1100T may place, in a group, an index that is associated with the beam with AoD₁ and an index that is associated with the beam with AoD₂. The Tx 1100T may then transmit (step 1110), to the Rx 1100R, an indication of the indices that have been placed into the group.

The accuracy and precision of angular separation measurement for the two beams is limited to the angular resolution of the Tx 1100T as well as the ability of the Tx 1100T to transmit beams with 1-D or 2-D angles. The angular separation can be defined as the cosine of the angle between the two transmit beam unit vectors. The angular range may be set differently for each angle. For example, threshold one may be used for azimuth angle and threshold two may be used for elevation angle. The Tx 1100T may group the beams based on the resulting relation of the one or more angles. In one example, the Tx 1100T may group any Tx beams when either angle (e.g., the azimuth angle or the elevation angle) meets a configured threshold. In another example, the Tx 1100T may group Tx beams when all angles meet the configured thresholds. The used thresholds for the angular constraints may be configured and may change according to the Rx location in relation to the Tx 1100T. In another scenario, the used thresholds may be defined by a standard.

In a further approach, the Tx 1100T may directly transmit (step 1110), to the Rx 1100R, a recommendation for each beam. For example, the Tx 1100T may transmit (step 1110), to the Rx 1100R, beams that have been arranged into two groups. A first group of beams may include beams that the Tx 1100T recommends as good for beam switching/tracking. The beams in the first group may, e.g., be beams with AoDs that are angularly sequential. A second group of beams may be good candidates for beam failure recovery. The beams in the second group may, e.g., be beams with different AoD or with independent or inverse blockage probability. The number of beams in each group may be configured by the Rx 1100R or may be fixed.

In an even further approach, the Tx 1100T may employ indirect signaling by way of forming quasi-co-location (QCL) associations. An example QCL association may be used for hierarchical beam refinement. A subset of relatively narrow beams (for example, spanned by a CSI-RS) may be considered to all be QCL associated with a relatively wide beam spanned by an SSB or by a distinct CSI-RS. Upon receipt (step 1112) of beam information signaling from the Tx 1100T, the Rx 1100R may infer, as part of processing (step 1114) the beam information, that beams within the same subset of QCL associated beams as the communicating beam are suitable candidate beams for beam tracking. The Rx 1100R may also infer, as part of processing (step 1114) the beam information, that within in a subset of QCL associated beams distinct from the subset of QCL associated beams that include the communicating beam are suitable candidate beams for BFR.

The aforementioned approaches are general examples that are, by no means, intended to be limiting examples. It should be clear that aspects of the present application span all possible forms of communication that is associated with channel-path-to-beam mapping.

To categorize the beams for possible beam switching/tracking and for possible beam failure recovery, the Rx 1100R may use its own AoA information, received AoD information (whether explicit or implicit), beam information and any sensing information. The beams categorized for beam switching/tracking may be continuously monitored until a decision is made to switch to a new beam. In such case, the Rx 1100R transmits a request to the Tx 1100T for an Rx-initiated beam switching procedure. Beams categorized for possible beam failure recovery may be used by the Rx 1100R responsive to a failure of the communicating beam. The Rx 1100R may inform the Tx 1100T of the beams that will be used for beam failure recovery, if different from Tx decision. While channel-path-to-beam mapping, according to aspects of the present application, may be shown to provide information regarding spatial behavior of various channel paths, sensing information may provide additional information that can also be helpful. For example, sensing information regarding the Rx 1100R movements may suggest certain beams to be used for beam switching/tracking or for possible beam recovery. Also, sensing information may predict blockages along certain directions that may provide more information regarding proactive beam switching.

In the foregoing, there has been a focus on the case wherein AoD is communicated (step 1110) and the Rx 1100R determines (step 1114) how channel paths may be mapped to beams. While this is a common scenario, there are other scenarios that are important as well. In one example, in sidelink communication, a first UE acts as the Rx 1100R and a second UE acts as the Tx 1100T. The first UE may send AoA information to a BS. The second UE may transmit Tx beam information to the BS. Accordingly, the BS may use the Tx beam information from the second UE, AoA information from the first UE and any related information to obtain a channel-path-to-beam mapping. Then the BS may provide the first UE and/or the second UE with configuration information designed to exploit the channel-path-to-beam mapping.

In another example, a micro-cell and a UE may be UL communicating and AoD information may be conveyed to a macro-cell, thereby allowing the macro-cell to obtain a channel-path-to-beam mapping.

In a further example, another network entity, which is neither Tx or Rx, may obtain a channel-path-to-beam mapping based on AoD information from a Tx.

In general, an entity obtaining a channel-path-to-beam mapping based on Tx AoD information may be the Rx or another network entity.

The Tx 1100T may transmit (step 1110) the beam information with a different periodicity than the periodicity with which RSRP measurements are transmitted and the periodicity with which feedback is received. In one example, the Tx 1100T may transmit (step 1110) the beam information and may continue sweeping these beams, without sending the information again, as long as the transmitted beams remain unchanged, e.g., through a beam tracking to update. In another example, the Tx 1100T may only transmit (step 1110) the beam information when requested by the Rx 1100R for the beams periodically swept. In a third example, the Tx 1100T may transmit (step 1110) the beam information only for beams configured by the Rx 1100R and these configured beams may be the same or different from the beams being swept by the Tx 1100T. In another example, the Tx 1100T updates the reported AoD if there is a change in the preferred grouping or significant change in the AoD associated to one or multiple channel paths/beams. In the above-mentioned examples, the Tx 1100T may use RRC signaling to report the AoD information in any of the proposed formats.

Aspects of the present application may be applied in a scenario wherein the Tx is a BS and the Rx is a UE. In such a scenario, the downlink beams that are transmitted may include SSB or CSI-RS. Aspects of the present application may be applied in a scenario wherein the Tx is a UE and the Rx is a BS. In such a scenario, the uplink beams that are transmitted may include beams for uplink training, such as SRS. Aspects of the present application may also be applied for a sidelink scenario, wherein both the Tx and the Rx are UEs.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
transmitting a pilot signal on a beam;
receiving angle-of-arrival associated information for the beam, the angle-of-arrival associated information being obtained by processing a measurement of the pilot signal; and
transmitting beam characterization information for the beam, the beam characterization information being obtained by processing the angle-of-arrival associated information.

2. The method of claim 1, wherein the beam characterization information comprises an indication that the beam is a candidate for a beam switching procedure in respect of a distinct beam.

3. The method of claim 1, wherein the beam characterization information comprises an indication that the beam is a candidate for a beam failure recovery procedure in respect of a distinct beam.

4. The method of claim 1, wherein the angle-of-arrival associated information comprises a quantized version of a value of an angle of arrival of the beam.

5. The method of claim 1, wherein the angle-of-arrival associated information comprises an index that corresponds, in a codebook, to the beam.

6. An apparatus comprising:
at least one processor coupled to a memory storing computer-readable instructions, wherein the apparatus is caused, by executing the computer-readable instructions, to:
transmit a pilot signal on a beam;
receive angle-of-arrival associated information for the beam, the angle-of-arrival associated information being obtained by processing a measurement of the pilot signal; and
transmit beam characterization information for the beam, the beam characterization information being obtained by processing the angle-of-arrival associated information.

7. The apparatus of claim 6, wherein the beam characterization information comprises an indication that the beam is a candidate for a beam switching procedure in respect of a distinct beam.

8. The apparatus of claim 6, wherein the beam characterization information comprises an indication that the beam is a candidate for a beam failure recovery procedure in respect of a distinct beam.

9. The apparatus of claim 6, wherein the angle-of-arrival associated information comprises a quantized version of a value of an angle of arrival of the beam.

10. The apparatus of claim 6, wherein the angle-of-arrival associated information comprises an index that corresponds, in a codebook, to the beam.

11. A method comprising:
receiving a pilot signal on a beam;
transmitting angle-of-arrival associated information for the beam, the angle-of-arrival associated information being obtained by processing a measurement of the pilot signal; and
receiving beam characterization information for the beam, the beam characterization information being obtained by processing the angle-of-arrival associated information.

12. The method of claim 11, wherein the beam characterization information comprises an indication that the beam is a candidate for a beam switching procedure in respect of a distinct beam.

13. The method of claim 11, wherein the beam characterization information comprises an indication that the beam is a candidate for a beam failure recovery procedure in respect of a distinct beam.

14. The method of claim 11, wherein the angle-of-arrival associated information comprises a quantized version of a value of an angle of arrival of the beam.

15. The method of claim 11, wherein the angle-of-arrival associated information comprises an index that corresponds, in a codebook, to the beam.

16. An apparatus comprising:
at least one processor coupled to a memory storing computer-readable instructions, wherein the apparatus is caused, by executing the computer-readable instructions, to:
receive a pilot signal on a beam;
transmit angle-of-arrival associated information for the beam, the angle-of-arrival associated information being obtained by processing a measurement of the pilot signal; and
receive beam characterization information for the beam, the beam characterization information being obtained by processing the angle-of-arrival associated information.

17. The apparatus of claim 16, wherein the beam characterization information comprises an indication that the beam is a candidate for a beam switching procedure in respect of a distinct beam.

18. The apparatus of claim 16, wherein the beam characterization information comprises an indication that the beam is a candidate for a beam failure recovery procedure in respect of a distinct beam.

19. The apparatus of claim 16, wherein the angle-of-arrival associated information comprises a quantized version of a value of an angle of arrival of the beam.

20. The apparatus of claim 16, wherein the angle-of-arrival associated information comprises an index that corresponds, in a codebook, to the beam.
